(19) United States
(12) Patent Application Publication
(10) Pub. No.: US 2019/0361480 A1
(43) Pub. Date: Nov. 28, 2019

(54) ACCELERATOR PEDAL FOR VEHICLE

(71) Applicant: KYUNG CHANG INDUSTRIAL CO., Ltd., Daegu (KR)

(72) Inventors: Hyeon Uk KIM, Daegu (KR); Jong Hee HAN, Daegu (KR); Ki Chul HYUN, Daegu (KR)

(21) Appl. No.: 16/401,716

(22) Filed: May 2, 2019

(30) Foreign Application Priority Data
May 23, 2018 (KR) 10-2018-0058556

(51) Int. Cl. G05G 5/05; G05G 1/44; B60K 26/02

(52) U.S. Cl. CPC G05G 5/05; G05G 2505/00; B60K 26/02; G05G 1/44

(57) ABSTRACT

An accelerator pedal for a vehicle, which has a hysteresis generation structure, is provided. The accelerator pedal includes: a housing including a pivot shaft; a pedal unit which is rotatably connected to the pivot shaft and has a pivot hole; a hysteresis generation member which receives a portion of the pedal unit and has an extension part that hits against the pedal unit and rotating in a direction in which the pedal unit rotates, when the pedal unit is rotated by applying a force to the pedal unit; and an elastic member which has an end connected to the extension part of the hysteresis generation member and applies an elastic force to the hysteresis generation member. When the force applied to the pedal unit is removed, the hysteresis generation member rotates in an opposite direction to the rotation direction of the pedal unit.

### CROSS-REFERENCE TO RELATED APPLICATIONS

This application claims priority from Republic of Korea Patent Application No. 10-2018-0058556, filed on May 23, 2018, which is hereby incorporated by reference for all purposes as if fully set forth herein.

### BACKGROUND

### Field

The present disclosure relates to an accelerator pedal for a vehicle and more particularly to an accelerator pedal for a vehicle, which has a hysteresis generation structure.

### Description of the Related Art

An accelerator pedal allows a user to accelerate the rotation of an engine. When the user intends to accelerate by increasing the rotation speed of the engine, the user steps on the accelerator pedal. When the user intends to reduce the rotation speed of the engine, the user takes one's foot off the accelerator pedal. The accelerator pedal is connected to a throttle valve by wire and linkage. The throttle valve is opened by stepping on the accelerator pedal, so that air is introduced into the cylinder. Then, an electronic control fuel injection device detects the amount of air and supplies gasoline suitable for the engine operating condition.

The accelerator pedal includes a mechanical accelerator pedal and an electronic accelerator pedal. In the mechanical accelerator pedal, the throttle valve of the engine and the accelerator pedal are mechanically connected to each other by a cable. In the electronic accelerator pedal, the position of the pedal is sensed by a sensor and the operation of the throttle is controlled based on the sensed position signal.

The mechanical accelerator pedal causes operational problems due to ambient environment, temperature changes, the deterioration of the cable, etc. Therefore, at present, the mechanical accelerator pedal has been replaced by the electronic accelerator pedal. The electronic accelerator pedal requires no cable. Accordingly, the electronic accelerator pedal has advantages of having enough installation space thereof, of reducing the fatigue of a driver, and of improving the fuel efficiency.

However, the driver prefers the tactile response felt by the driver in a conventional mechanical accelerator pedal. Also, in order to reduce the fatigue of the driver due to the operation of the electronic accelerator pedal, hysteresis must be generated. The hysteresis effect reduces the fatigue caused by the repeated operation of the driver.

A hysteresis generation technology applied to a conventional electronic accelerator pedal includes a structure friction method, a housing friction method, and the like. However, these methods have a complex structure and require a lot of parts.

### SUMMARY

A purpose of the present disclosure is to provide an accelerator pedal for a vehicle, which is capable of reducing ankle fatigue of a driver who operates the accelerator pedal repetitively.

Another purpose of the present disclosure is to provide the accelerator pedal for a vehicle, which is capable of providing the hysteresis effect with a simple configuration. However, the object of the present disclosure is not limited to the above description and can be variously extended without departing from the scope and spirit of the present disclosure.

One embodiment is an accelerator pedal for a vehicle, which has a hysteresis generation structure. The accelerator pedal includes: a housing including a pivot shaft; a pedal unit which is rotatably connected to the pivot shaft and has a pivot hole into which the pivot shaft is inserted; a hysteresis generation member which receives a portion of the pedal unit and has an extension part, the extension part hitting against the pedal unit and rotating in a direction in which the pedal unit rotates, when the pedal unit is rotated by applying a force to the pedal unit; and an elastic member which has an end connected to the extension part of the hysteresis generation member and applies an elastic force to the hysteresis generation member. When the force applied to the pedal unit is removed, the hysteresis generation member rotates in an opposite direction to the rotation direction of the pedal unit by the elastic force of the elastic member.

The accelerator pedal may further include a pivot bushing between the pivot shaft and the pedal unit.

The pedal unit may include a hinge having a pivot hole.

The pedal unit may include a pedal pad to which a driver applies a force, a hinge which is connected to the housing, and a pedal arm which connects the pedal pad and the hinge.

The pedal unit may further include a protrusion which is formed at a connection portion between the pedal arm and the hinge and hits against the hysteresis generation member when the pedal unit is rotated.

### BRIEF DESCRIPTION OF THE DRAWINGS

FIG. 1 shows an accelerator pedal for a vehicle according to an embodiment of the present disclosure;

FIG. 2 is an exploded perspective views showing the accelerator pedal for a vehicle shown in FIG. 1 according to an embodiment of the present disclosure;

FIG. 3 is a perspective view of a pedal unit according to the embodiment of the present disclosure;

FIGS. 4 and 5 are views for describing the operation of the accelerator pedal for a vehicle of FIG. 1 according to an embodiment of the present disclosure; and

FIG. 6 is a view mimetically showing the operation principle of the pedal unit according to the embodiment of the present disclosure.

### DETAILED DESCRIPTION

The following detailed description of the present disclosure shows a specified embodiment of the present invention and will be provided with reference to the accompanying drawings. The embodiment will be described in enough detail that those skilled in the art are able to embody the present invention. It should be understood that various embodiments of the present disclosure are different from each other and need not be mutually exclusive. For example, a specific shape, structure and properties, which are described in this disclosure, may be implemented in other embodiments without departing from the spirit and scope of the present disclosure with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereinafter, an accelerator pedal for a vehicle, which has a hysteresis generation structure according to an embodiment of the present invention will be described with reference to the accompanying drawings.

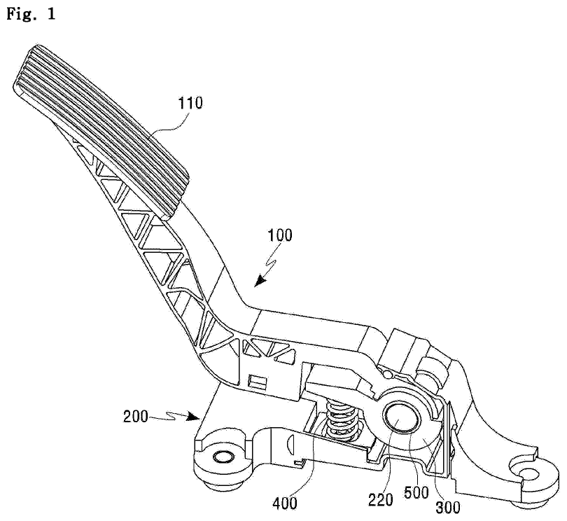

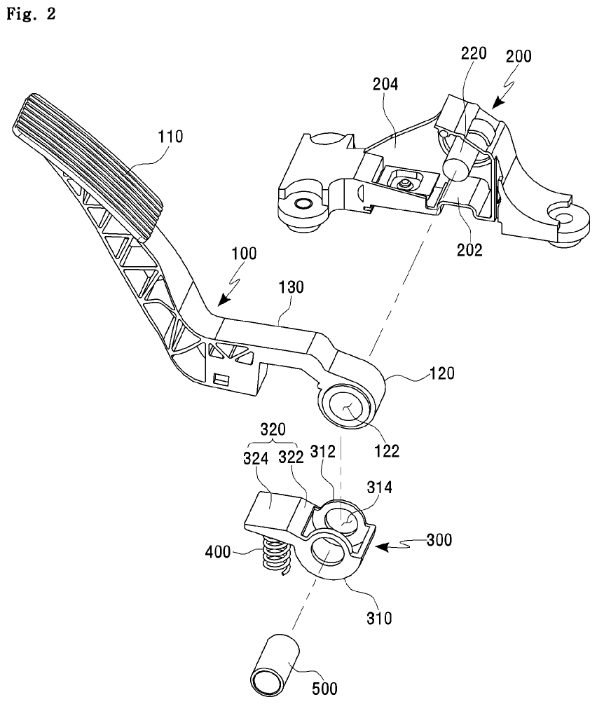

FIG. 1 shows an accelerator pedal for a vehicle according to the embodiment of the present disclosure. FIG. 2 is an exploded perspective views showing the accelerator pedal for a vehicle shown in FIG. 1.

Referring to FIGS. 1 to 2, the accelerator pedal for a vehicle according to the embodiment of the present disclosure may include a pedal unit 100, a housing 200, a hysteresis generation member 300, and an elastic member 400.

The housing 200 includes a base 202, a sidewall 204, and a pivot shaft 220 protruding from the sidewall 204 approximately perpendicular to the sidewall 204. The pedal unit 100 is rotatably coupled to the pivot shaft 220. Specifically, a hinge 120 of the pedal unit 100 includes a pivot hole 122 into which the pivot shaft 220 is inserted.

The pedal unit 100 is rotatably connected to the pivot shaft 220 of the housing 200.

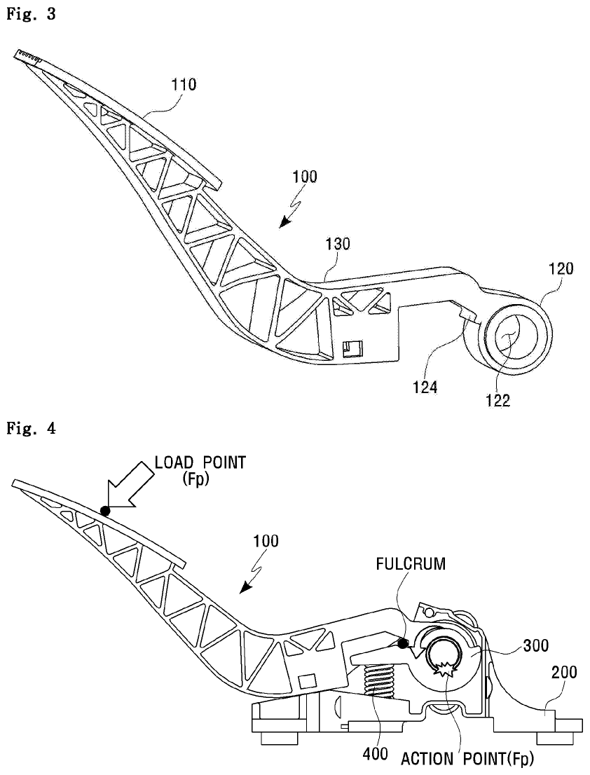

FIG. 3 is a perspective view of the pedal unit according to the embodiment of the present invention.

Referring to FIG. 3, the pedal unit 100 includes a pedal pad 110 to which a driver applies a pedal effort, the hinge 120 which is connected to the housing 200, and a pedal arm 130 which connects the pedal pad 110 and the hinge 120. The pedal pad 110 may be formed to have a flat surface or may be outwardly curved at a predetermined curvature, in order to allow the driver to easily operate.

The hinge 120 may have a cylindrical shape for allowing the pedal unit 100 to easily rotate. Also, the hinge 120 includes a protrusion 124 which hits against the hysteresis generation member 300. The protrusion 124 may be formed at a connection portion between the hinge 120 and the pedal arm 130. When the pedal unit 100 is rotated by the pedal effort, the protrusion 124 hits against the hysteresis generation member 300. That is to say, when the pedal unit 100 is rotated by the pedal effort, the protrusion 124 of the pedal unit 100 contacts and pushes the hysteresis generation member 300.

The hysteresis generation member 300 receives a portion of the pedal unit 100, i.e., the hinge 120 of the pedal unit 100. The hysteresis generation member 300 receives the pedal unit 100 in such a manner that the pedal unit 100 can rotate. The hysteresis generation member 300 includes a receiving portion 310 which receives the hinge 120 of the pedal unit 100. For example, the receiving portion 310 has a semi-cylindrical shape for receiving the lower portion of the hinge 120 of the pedal unit 100. Also, the receiving portion 310 has a support 312 and an opening 314. The support 312 supports the pivot shaft 220 of the housing 200. The pivot shaft 220 of the housing 200 passes through the opening 314.

The hysteresis generation member 300 is disposed between the pedal unit 100 and the housing 200. Specifically, the hysteresis generation member 300 is disposed such that an extension part 320 is disposed under the pedal arm 130. The hysteresis generation member 300 includes the extension part 320 which extends from the receiving portion 310.

When the pedal unit 100 is rotated by applying a force to the pedal unit 100, the extension part 320 hits against the pedal unit 100, and thus counterclockwise receives the force from the pedal unit 100. Also, when the force is removed from the pedal unit 100, the extension part 320 receives the force counterclockwise by the restoring force of the elastic member 400. The extension part 320 includes a connecting portion 322 and a pressed portion 324. The connecting portion 322 is connected to the receiving portion 310. The pressed portion 324 is coupled to the elastic member 400.

The connecting portion 322 of the extension part 320 is connected to the protrusion 124 of the pedal unit 100. Therefore, the connecting portion 322 of the extension part 320 is formed to have the same inclination as that of the surface of the protrusion 124. The pressed portion 324 is connected to the elastic member 400 and applies or receives a force to or from the elastic member 400. Though not shown, the pressed portion 324 may have a fixing groove which is formed in the bottom surface thereof and fixes the elastic member 400.

The elastic member 400 is disposed under the pedal arm 130 and on the base 202 of the housing 200. The elastic member 400 may be, for example, a spring.

The accelerator pedal for a vehicle according to the embodiment of the present disclosure further includes a pivot bushing 500 disposed between the pivot shaft 220 of the housing 200 and the pedal unit 100. The pivot bushing 500 may increase a surface frictional force between the pivot shaft 220 of the housing 200 and the pedal unit 100.

Specifically, when the hinge 120 of the pedal unit 100 rotates in contact with the hysteresis generation member 300, the pivot bushing 500 comes in surface contact with the pivot shaft 220 and the pedal unit 100 between the pivot shaft 220 and the pedal unit 100, and the frictional force is hereby increased.

Meanwhile, an electronic accelerator pedal position (APP) sensor (not shown) senses the rotation amount of the pedal arm and generates an electrical signal and then transmits to a throttle controller. The throttle controller (not shown) operates an actuator (not shown) on the basis of the electrical signal received from the sensor, so that the opening and closing of a throttle valve is controlled and combustion amount is controlled.

When the driver takes his/her foot off the pedal pad 110, the pedal arm 130 is rotated in the opposite direction to the rotation direction thereof by an elastic force of the pressed elastic member 400 and returns to its initial position.

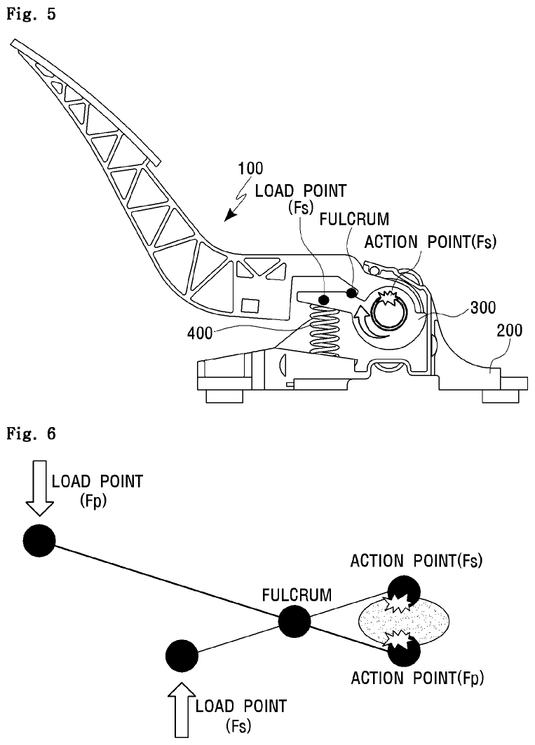

FIGS. 4 and 5 are views for describing the operation of the accelerator pedal for a vehicle of FIG. 1. FIG. 6 is a view mimetically showing the operation principle of the pedal unit according to the embodiment of the present disclosure.

Referring to FIGS. 4 and 6, it is shown that the driver applies a force to the pedal pad for acceleration.

The elastic member 400 is disposed under the pedal arm 130. When the driver steps on the pedal pad 110, the force is applied to the pedal unit 100. When the force is applied to the pedal unit 100, the pedal unit 100 rotates counterclockwise around the pivot shaft 220, and then the elastic member 400 is pressed.

In this case, a load point Fp is formed at the position of the pedal pad 110. The pedal unit 100 pushes the hysteresis generation member 300 counterclockwise. Specifically, the protrusion 124 of the pedal unit 100 hits against the extension part 320 of the hysteresis generation member 300, so that a fulcrum is formed at the protrusion 124 of the pedal unit 100.

The fulcrum acts as the fulcrum of the principle of the first-class lever. In the first-class lever, the fulcrum is, as shown in FIG. 6, located between the action point and the load point. In the first-class lever, when the magnitudes of the force applied to the action point and the load point are determined, the longer the length from the fulcrum to the load point is, the easier the lever is moved even though the forces Fp and Fs applied to the load point are small. Here, the direction in which the force applied to the load point is, as shown in FIG. 6, opposite to the direction in which the force applied to the action point.

Accordingly, the hinge 120 of the pedal unit 100 receives an upward force with respect to the fulcrum. In other words, when the pedal unit 100 rotates counterclockwise and the hinge 120 of the pedal unit 100 receives an upward force, the frictional force is increased between the pivot shaft 220 and the lower portion of the hinge 120. That is to say, the frictional force between the inner surface of the hinge 120 and the outer surface of the pivot bushing 500 is increased in the lower portion of the hinge 120, so that the hysteresis is generated.

Referring to FIGS. 5 and 6, it is shown that the driver removes the force applied to the pedal pad.

When the driver, for example, takes his/her foot off the pedal pad 110, the force applied to the pedal unit 100 is removed. When the force is removed from the pedal unit 100, the elastic member 400 pressed under the pedal arm 130 is restored.

In this case, the load point Fs is formed on the elastic member 400. The elastic member 400 pushes the hysteresis generation member 300 clockwise while being restored. When the elastic member 400 pushes the hysteresis generation member 300, the pedal unit 100 rotates clockwise.

Specifically, when the hysteresis generation member 300 rotates clockwise by the restoring force of the elastic member 400, the pedal unit 100 rotates clockwise by the restoring force of the elastic member 400 through the hysteresis generation member 300. Here, the extension part 320 of the hysteresis generation member 300 hits against the protrusion 124 of the pedal unit 100, so that the fulcrum is formed on the protrusion 124 of the pedal unit 100. The fulcrum acts as the fulcrum of the principle of the lever. Accordingly, the hinge 120 of the pedal unit 100 receives a downward force with respect to the fulcrum.

Namely, when the pedal unit 100 rotates clockwise and the hinge 120 of the pedal unit 100 receives a downward force, the frictional force is increased between the pivot shaft 220 and the upper portion of the hinge 120. That is to say, the frictional force between the inner surface of the hinge 120 and the outer surface of the pivot bushing 500 is increased in the lower portion of the hinge 120, so that the hysteresis is generated.

As such, the hysteresis effect can be produced by the simple structure.

The features, structures and effects and the like described in the embodiments are included in one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. An accelerator pedal for a vehicle, the accelerator pedal comprising:
a housing comprising a pivot shaft;
a pedal unit which is rotatably connected to the pivot shaft and has a pivot hole into which the pivot shaft is inserted;
a hysteresis generation member which receives a portion of the pedal unit and has an extension part, the extension part hitting against the pedal unit and rotating in a direction in which the pedal unit rotates, when the pedal unit is rotated by applying a force to the pedal unit; and
an elastic member which has an end connected to the extension part of the hysteresis generation member and applies an elastic force to the hysteresis generation member,
wherein, when the force applied to the pedal unit is removed, the hysteresis generation member rotates in an opposite direction to a rotation direction of the pedal unit by the elastic force of the elastic member.

2. The accelerator pedal for the vehicle of claim 1, further comprising:
a pivot bushing between the pivot shaft and the pedal unit.

3. The accelerator pedal for the vehicle of claim 1, wherein the pedal unit comprises a hinge having a pivot hole.

4. The accelerator pedal for the vehicle of claim 1, wherein the pedal unit comprises a pedal pad to which a driver applies a force, a hinge which is connected to the housing, and a pedal arm which connects the pedal pad and the hinge.

5. The accelerator pedal for the vehicle of claim 4, wherein the pedal unit further comprises:
a protrusion which is formed at a connection portion between the pedal arm and the hinge and hits against the hysteresis generation member when the pedal unit is rotated.
